(19) United States
(12) Patent Application Publication
(10) Pub. No.: US 2020/0001894 A1
(43) Pub. Date: Jan. 2, 2020

(54) INFORMATION PROCESSING APPARATUS, INFORMATION PROCESSING SYSTEM, AND INFORMATION PROCESSING METHOD

(71) Applicant: TOYOTA JIDOSHA KABUSHIKI KAISHA, Toyota-shi (JP)

(72) Inventors: Yusuke KANEKO, Toyota-shi (JP); Junya MASUI, Nagoya-shi (JP); Yui NAKAMURA, Nagoya-shi (JP); Ai FUJIMURA, Nisshin-shi (JP); Keisuke TSUJIMOTO, Toyota-shi (JP); Tomoyuki KURIYAMA, Hadano-shi (JP)

(73) Assignee: TOYOTA JIDOSHA KABUSHIKI KAISHA, Toyota-shi (JP)

(21) Appl. No.: 16/456,079

(22) Filed: Jun. 28, 2019

(30) Foreign Application Priority Data
Jun. 28, 2018 (JP) 2018-123111

(51) Int. Cl. B60W 50/14; G07C 5/00

(52) U.S. Cl. CPC B60W 50/14; B60W 2540/28; G07C 5/008

(57) ABSTRACT

An information processing apparatus includes a processor that executes acquiring first information relating to an intention of at least one of a plurality of users traveling in the same vehicle regarding a traveling environment in the vehicle and transmit ting the first information to at least an apparatus associated with the vehicle. The processor may further execute evaluating the first information, generating an evaluation result and transmitting the evaluation result to the apparatus associated with the vehicle.

### CROSS REFERENCE TO RELATED APPLICATION

This application claims the benefit of Japanese Patent Application No. 2018-123111, filed on Jun. 28, 2018, which is hereby incorporated by reference herein in its entirety.

### BACKGROUND

### Technical Field

The present disclosure relates to a technique for a plurality of users to travel by sharing the same vehicle.

### Description of the Related Art

Travelling modes in which a plurality of passengers travel by sharing one vehicle for the purpose of relieving traffic congestion, saving fuel expenses, environment countermeasures or the like (ride sharing) are becoming popular mostly in foreign countries. Furthermore, in such a traveling mode, techniques for matching a plurality of users are being developed.

As a technique associated with this, Patent Document 1 describes a system that acquires data relating to interactions carried out by a plurality of users traveling by sharing the same vehicle and further provides information based on the interactions,

### CITATION LIST

### Patent Document

[Patent document 1] US Patent Application Publication No. 2017/0351990

Since it is often the case that in general ride sharing, people who are strangers to one another travel by sharing the same vehicle, it may be difficult to communicate, for example, one passenger's request or intention regarding an in-vehicle environment or the like to other fellow passengers.

The present disclosure has been implemented in view of the above problem, and it is an object of the present disclosure to facilitate, when a plurality of users travel by sharing the same vehicle, communication of a riding user's intention regarding a traveling environment in the vehicle.

### SUMMARY

One aspect of the present disclosure is an information processing apparatus comprising a processor configured to:

acquire first information relating to an intention of at least one of a plurality of users traveling in a same vehicle regarding a traveling environment in the vehicle; and

transmit the first information to at least an apparatus associated with the vehicle.

Another aspect of the present disclosure is an information processing system comprising at least one processor configured to:

acquire first information relating to an intention of at least one of a plurality of users traveling in a same vehicle regarding a traveling environment in the vehicle; and

transmit the first information to at least an apparatus associated with the vehicle.

Another aspect of the present disclosure is an information processing method comprising:

acquiring first information relating to an intention of at least one of a plurality of users traveling in a same vehicle regarding a traveling environment in the vehicle; and

transmitting the first information to at least an apparatus associated with the vehicle.

Another aspect of the present disclosure is an information processing program for causing a computer to execute:

acquiring first information relating to an intention of at least one of a plurality of users traveling in a same vehicle regarding a traveling environment in the vehicle; and

transmitting the first information to at least an apparatus associated with the vehicle.

According to the present disclosure, when a plurality of users travel by sharing the same vehicle, it is possible to facilitate communication of a riding use intention regarding a traveling environment in the vehicle.

### BRIEF DESCRIPTION OF DRAWINGS

FIG. 1 is a diagram illustrating an example of a system configuration of a ride sharing service providing system according to a first embodiment;

FIG. 2 is a diagram illustrating an example of a system configuration of the user terminal;

FIG. 3 is a diagram illustrating an example of a questionnaire screen of the user terminal;

FIG. 4 is a diagram illustrating an example of a system configuration of the management server;

FIG. 5 is an example of a questionnaire answer information table. The questionnaire answer information table is stored in the questionnaire answer information DE;

FIG. 6 is an example of a flowchart of questionnaire answer evaluation processing of the reservation processing unit of the management server.

### DESCRIPTION OF THE EMBODIMENT

One aspect of the present disclosure is an information processing apparatus including a processor that executes acquiring first information relating to an intention of at least one of a plurality of users traveling in the same vehicle regarding a traveling environment in the vehicle and transmitting the first information to at least an apparatus associated with the vehicle.

The “traveling environment in the vehicle” is, for example, a surrounding environment of the user who is traveling in the vehicle. More specifically, the “traveling environment in the vehicle” is, for example, an environment inside the vehicle, a speed of the vehicle or the like. The environment inside the vehicle includes, for example, air conditioning, audio volume and fellow passengers.

The first information relating to an intention of at least one of the plurality of users who are traveling in the same vehicle regarding a traveling environment in the vehicle is amenity of the traveling environment in the vehicle, for example. The amenity is indicated, for example, in five stages. For example, the first information is acquired as an answer to a questionnaire with items concerning the traveling environment in the vehicle. The apparatus associated with the vehicle may he a terminal associated with a driver of the vehicle or a vehicle-mounted terminal mounted on the vehicle that specifies a traveling route of the vehicle. The terminal associated with the driver of the vehicle is, for example, a terminal held by the driver. Note that the vehicle may be a vehicle manually driven by the driver or an autonomously traveling vehicle. The vehicle-mounted terminal may be a navigation apparatus or a computer for autonomous traveling.

According to one aspect of the present disclosure, the user in the vehicle can communicate the user's intention regarding the traveling environment in the vehicle not verbally but indirectly via an information processing apparatus to the driver of the vehicle, for example, which facilitates communication. This can also reduce mental obstacles when people who are strangers to each other share the same vehicle, for example.

According to another aspect of the present disclosure, the processor may evaluate the first information, generate an evaluation result and transmit the evaluation result to the apparatus associated with the vehicle. By transmitting the evaluation result of the first information, for example, the evaluation result is informed to users sharing the vehicle and it is thereby possible to motivate any one user sharing the same vehicle to work on an improvement of the traveling environment.

According to a further aspect of the present disclosure, the processor may further generate an instruction for an adjustment of the traveling environment in the vehicle based on an evaluation result and transmit the generated instruction to the apparatus associated with the vehicle. This makes it possible for the vehicle to adjust the traveling environment in the vehicle and provide a comfortable environment to the users in the vehicle.

Furthermore, according to a still further aspect of the present disclosure, the processor may acquire the first information of some or all of the plurality of users in the same vehicle, evaluate the first information of some or all of the plurality of users and generate evaluation results. It is thereby possible to provide a traveling environment in the vehicle in which, for example, the plurality of users in the same vehicle feel comfortable. Furthermore, since evaluation results based on the first information of the plurality of users are transmitted to the apparatus associated with the vehicle, answer contents of each user are hidden, which may reduce mental obstacles about a possibility that an individual may be identified with answers to a questionnaire.

Hereinafter, more specific embodiments of the present disclosure will be described based on the accompanying drawings. A hardware configuration, a module configuration, a functional configuration or the like described in the respective embodiments is not intended to limit the technical scope of the disclosure thereto unless specified otherwise.

### First Embodiment

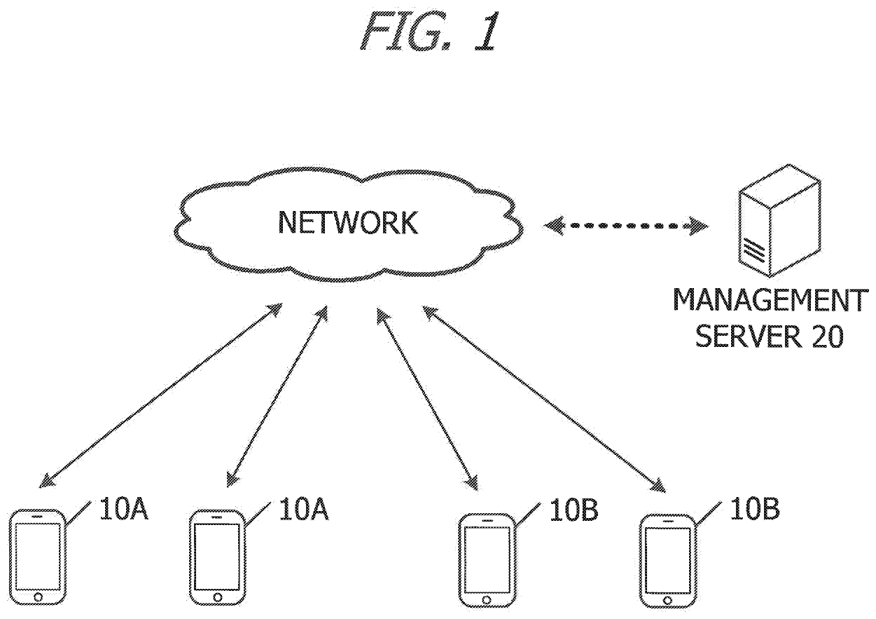

FIG. 1 is a diagram illustrating an example of a system configuration of a ride sharing service providing system 1 according to a first embodiment. The ride sharing service providing system 1 includes user terminals 10 carried by users and a management server 20. Hereinafter, a user who wants a ride a vehicle will he referred to as a “riding user” and a user who drives the vehicle will be referred to as a “driving user.” The management server 20 is an example of an “information processing apparatus.”

The user terminal 10 is constructed to be switchable between a mode available to a riding user (hereinafter referred to as a “riding user mode”) and a mode available to a driving user (hereinafter referred to as a “driver mode”). Hereinafter, the user terminal 10 operating in the riding user mode will be referred to as a “user terminal 10A.” On the other hand, the user terminal operating in the driver mode will be referred to as a “user terminal 10B.” When no distinction is made between the user terminal 10A and the user terminal 10B, the user terminal is simply referred to as a “user terminal 10.” Details of operation in each mode will be described later. The user terminal 10B is an example of the “apparatus associated with the vehicle” or the “terminal associated with the driver of the vehicle.”

The riding user registers the user's own traveling-related information in the management server 20 via the user terminal 1A. The “user's own traveling-related information” refers to, for example, a place of departure and destination of the riding user, a date and time at which the riding user wants to start traveling or the like. On the other hand, the driving user registers the user's own traveling-related information in the management server 20 via the user terminal 10B. The “traveling-related information” of the driving user namely refers to traveling-related information on the vehicle driven by the driving user. The traveling-related information is, for example, a date and time at which driving of the vehicle starts and a traveling route. The traveling-related information of the riding user and the traveling-related information of the driving user will be referred to as a “traveling schedule” hereinafter,

These information pieces can be generated and registered by, for example, application software for using a ride sharing service installed in the user terminal 10. However, these information pieces need not always be registered using the user terminal 10. For example, the information may be registered using an arbitrary terminal connectable to a network (a smartphone, a mobile phone, a tablet terminal, personal information terminal, a wearable computer or the like) or a personal computer.

The management server 20 is an apparatus that manages a traveling schedule registered by the user terminal 10 and matches between users. “Matching” means associating a driving user with a riding user based on a traveling schedule. The management server 20 matches between the users based on the registered traveling schedule and determines a traveling route of the vehicle driven by the driving user, a place at which the riding user is allowed to get in the vehicle, and a place at which the riding user is allowed to get out of the vehicle or the like.

Information resulting from the matching (hereinafter referred to as “matching information”) is transmitted to the user terminal 10A and the user terminal 10B. The matching information includes, for example, information on the vehicle driven by the driving user (a vehicle type, color, number plate information or the like), information on the riding user and the driving user (sex, age or the like), traveling-related information (a place where the riding user joins the: vehicle, a joining time, a traveling route, a place where the riding user gets out of the vehicle, a scheduled arrival time, presence or absence of other fellow passengers, traveling cost, and the like) or the like. When the respective users who acquire the matching information (the driving user and the riding users) approve the matching, the matching between the riding user and the driving user is confirmed. This allows the driving user to join the riding user to travel together. After joining, the driving user and the riding user in the same vehicle are an example of the “plurality of users traveling in the same vehicle.” Note that the “plurality of users traveling in the same vehicle” may include one driving user and a plurality of riding users.

In the ride sharing service providing system 1 according to the first embodiment, the user terminal 10A, the user terminal 103 and the management server 20 are mutually connected via a network. For example, a WAN (Wide Area Network) which is a worldwide scale public communication network such as the Internet and other communication networks may be adopted as the network. Furthermore, the network may include a telephone communication network such as a mobile phone and a wireless communication network such as Wi-Fi (registered trademark).

In the first embodiment, the riding user joins the matched driving user, gets in the vehicle and answers a questionnaire on a traveling environment for example, the user terminal 10A. The traveling environment includes, for example, an in-vehicle environment and a speed of the vehicle. The in-vehicle environment includes, for example, air conditioning, audio volume, fellow passengers and a speed of the vehicle. The questionnaire on the traveling environment includes a plurality of items, for example, and a plurality of alternatives are included in each item For example, the item “air conditioning” includes five alternatives of “hot,” “a little hot,” “comfortable,” “a little cold,” and “cold,” for example.

The questionnaire answer information of the riding user is transmitted to the management server 20. The management server 20 evaluates the questionnaire answer information of the riding user using a predetermined method and transmits an evaluation result to the user terminal 10B of the driving user. For example, when an answer result for the item of the riding user “air conditioning” is “cold,” the management server 20 evaluates that a temperature setting of air conditioning is too low and transmits the evaluation result to the user terminal 10B of the driving user. For example, upon receiving the evaluation result “the temperature setting of air conditioning is too low” from the management server 20, the driving user can adjust air conditioning of the vehicle and provide a comfortable in-vehicle environment to the riding user. The questionnaire answer information is an example of “first information on the intention regarding the traveling environment in the vehicle.”

When a plurality of riding users are traveling in the same vehicle, the management server 20 collects questionnaire answer information from all the riding users, totals the questionnaire answer information of all the riding users and evaluates the item of the traveling environment based on the totaling result. For example, numerical values are assigned to the respective alternatives, the management server 20 calculates a total value of the questionnaire answer information of all the riding users for each item and evaluates the item of the traveling environment based on the total value.

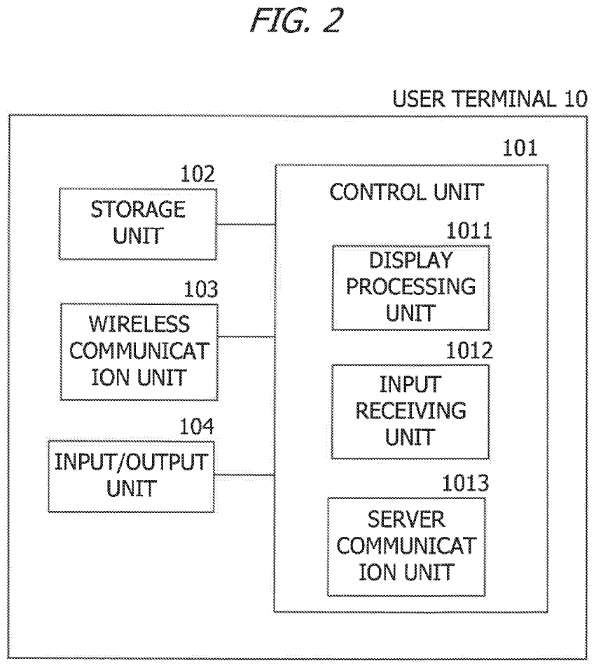

FIG. 2 is a diagram illustrating an example of a system configuration of the user terminal 10. The user terminal 10 is a small computer such as a smartphone, a mobile phone terminal, a tablet computer, a personal information terminal, a notebook computer or a wearable computer (a smart watch or the like). The user terminal 10 includes, for example, a control unit 101, a storage unit 102, a wireless communication unit 103 and an input/output unit 104 as hardware components.

The control unit 101 is an operation apparatus that manages control exercised by the user terminal 10. The control unit 101 can be implemented, for example, using an operation processing apparatus such as a CPU (Central Processing Unit). The control unit 101 is provided with, for example, a display processing unit 1011, an input receiving unit 1012 and a server communication unit 1013 as functional components. Each functional component is implemented, for example, by the control unit 101 executing a program stored in the storage unit 102, which will be described later.

The display processing unit 1011 executes processing of causing the input/output unit 104, which will be described later, to display a predetermined screen, for example. For example, in the first embodiment, the display processing unit 1011 causes the questionnaire screen to be displayed on a screen of the input/output unit 104.

The input receiving unit 1012 receives a user operation corresponding to the screen under display inputted from, for example, the input/output unit 104, which will be described later. More specifically, the input receiving unit 1012 receives a selection operation on alternatives on the questionnaire screen inputted to the input/output unit 104 and generates questionnaire answer information from contents of the selection operation. Upon receiving a transmission instruction operation of the questionnaire answer information on the questionnaire screen, inputted to the input/output unit 104, the input receiving unit 1012 instructs the server communication unit 1013 to transmit the questionnaire answer information to the management server 20.

The server communication unit 1013 is an interface with the management server 20. Upon receiving a transmission instruction of the questionnaire answer information from, for example, the input receiving unit 1012, the server communication unit 1013 transmits the questionnaire answer information to the management server 20 via the wireless communication unit 103.

The storage unit 102 includes, for example, a main memory device and an auxiliary storage device. The main memory device is a memory in which a program executed by the control unit 101 and data used by the control program are developed. The auxiliary storage device is an apparatus that stores a program executed by control unit 101 and data used by the control program. The auxiliary storage device may also store a program which is executed by the control unit 101 and packaged as an application. The auxiliary storage device may also store the operating system for executing the applications. The program stored in the auxiliary storage device is loaded into the main memory device and executed by the control unit 101 to thereby perform processing of the above-described functional components.

The main memory device may include a RAM (Random Access Memory) and a. ROM (Read Only Memory). The auxiliary storage device may include an EPROM (Erasable Programmable ROM) and a hard disk drive (HDD). Furthermore, the auxiliary storage device may also include a removable medium, that is, a removable recording medium. The removable medium is a USB (Universal Serial Bus) memory or a disk recording medium such as a CD (Compact Disc) or a DVD (Digital Versatile Disc).

The wireless communication unit 103 is a wireless communication interface for connecting the user terminal 10 to a network. The wireless communication unit 103 provides access to the network via a mobile communication service such as a wireless LAN, 3G, LTE or 5G.

The input/output unit 104 receives an input operation executed by a user and provides information to the user. In the first embodiment, the input/output unit 104 is a touch panel display. That is, in the first embodiment, the input/output unit 104 includes a liquid crystal display and control means therefor and a touch panel and control means therefor.

Note that the configuration illustrated in FIG. 2 is an example and all or some of the illustrated functions may be executed using a specially designed circuit. A program thereof may be stored or executed by a combination of a main memory device and an auxiliary storage device other than those illustrated.

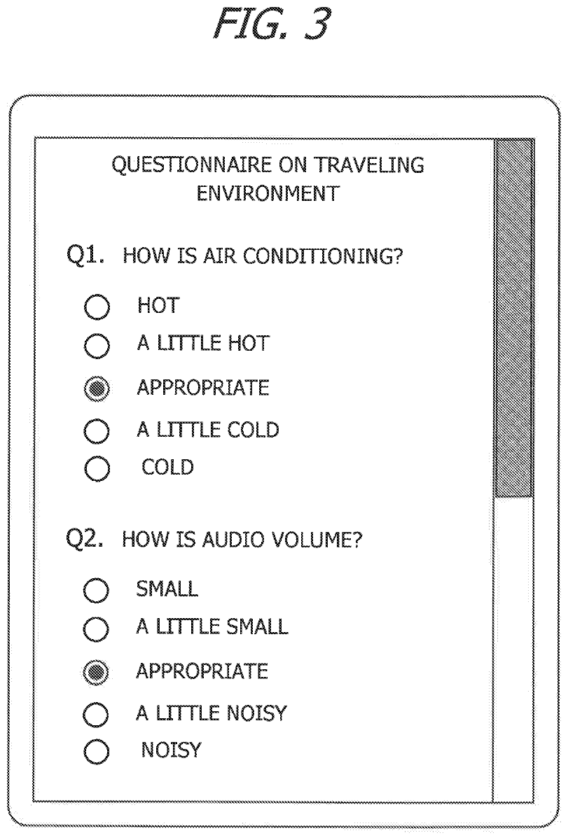

FIG. 3 is a diagram illustrating an example of a questionnaire screen of the user terminal 10A. The questionnaire screen is displayed when the riding user selects it from a menu screen of the application software for using the ride sharing service of the user terminal 10A or displayed when the management server 20 is notified of completion of riding in the vehicle of the driver and the questionnaire screen is received from the management server 20.

The questionnaire screen illustrated in FIG. 3 displays items relating to air conditioning and audio volume. For the item relating to air conditioning, the screen displays five alternatives of “hot,” “a little hot,” “appropriate,” “a little cold” and “cold.” For the item relating to audio volume, the screen displays five alternatives of “noisy,” “a little noisy,” “appropriate,” “small” and “a little small.”

For example, when the questionnaire screen is generated by the management server 20, the items of the traveling environment displayed on the questionnaire screen may also be determined, for example, according to conditions of the vehicle. For example, when air conditioning, audio equipment or the like is not ON in the vehicle, these items are not included in the questionnaire screen generated by the management server 20. Note that the conditions of the vehicle may be notified from the user terminal 10B of the driver to the management server 20 or notified from a vehicle-mounted apparatus of the vehicle to the management server 20, for example. However, without being limited to this, the storage unit 102 of the user terminal 10A may store a questionnaire screen with display items set in advance.

The questionnaire screen illustrated in FIG. 3 displays a part thereof and the remaining part of the questionnaire screen is displayed by scrolling the screen. For example, the item relating to the traveling environment may also include items related to fellow passengers and a driving speed. The item related to the fellow passengers includes five alternatives of “annoying,” “a little annoying,” “no problem,” “a little friendly” and “friendly,” for example. The item related to the driving speed includes five alternatives of “fast,” “a little fast,” “appropriate,” “a little slow” and “slow.”

For example, a “Send” button is disposed at the bottom of the questionnaire screen and when the riding user selects the “Send” button, an operation for instructing transmission of the questionnaire answer information is inputted to the user terminal 10A.

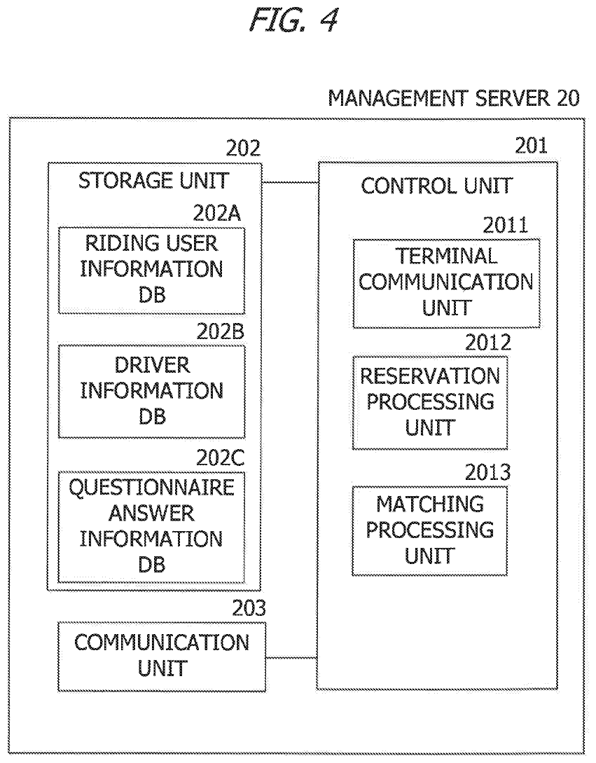

FIG. 4 is a diagram illustrating an example of a system configuration of the management server 20. The management server 20 is constructed of a general computer. That is, the management server 20 is computer including a processor such as a CPU or a GPU, a main memory device such as a RAM or a ROM, and an auxiliary storage device such as an EPROM, a hard disk drive or a removable medium. Note that the removable medium may be a USE memory or a disk recording medium such as a CD or a DVD, for example. It is possible to implement the respective functions that match a predetermined purpose as will be described later by storing an operating system (OS), various programs, various tables or the like in the auxiliary storage device, loading the program stored therein into a work area of the main memory device, executing the program and controlling the respective components or the like through execution of the program. However, some or all of the functions may be implemented by a hardware circuit such as an ASIC or an FPGA. Note that the management server 20 may be constructed of a single computer or constructed of a plurality of computers cooperating with one another.

The management server 20 includes a control unit 201, a storage unit 202 and a communication unit 203. The communication unit 203 is a communication interface for connecting the management server 20 to a network. The communication unit 203 is constructed by including, for example, a network interface board or a wireless communication circuit for wireless communication.

The storage unit 202 is constructed by including a main memory device and an auxiliary storage device. The main memory device is a memory in which a program executed by the control unit 201 and data used by the control program are developed. The auxiliary storage device is an apparatus that stores the program executed by the control unit 201 and data used by the control program. The main memory device and the auxiliary storage device are similar to the storage unit 102, and so detailed description will be omitted.

The storage unit 202 includes a riding user information database (DB) 202A, a driver information DB 202B and a questionnaire answer information DB 202C. The riding user information DB 202A, the driver information DB 202B and the questionnaire answer information DB 202C are constructed, for example, by a program of a database management system (DBMS) executed by the control unit 201 managing data stored in the storage unit 202. The Ag user information DB 202A, the driver information DB 202B and the questionnaire answer information DB 202C are, for example, relational databases.

The riding user information DB 202A is a database storing riding user information acquired from the user terminal 10A. The riding user information includes, for example, user identification information of the riding user, a place of departure, a destination and a date and time at which the user wants to start traveling or the like.

The driving user information DB 202B is a database storing driving user information acquired from the user terminal 10B. The driving user information includes, for example, user identification information of the driving user, a date and time at which driving of the vehicle starts, a traveling route or the like

The questionnaire answer information DB 202C stores questionnaire answer information received from, for example, the user terminal 10A of the riding user. Details of the information stored in the questionnaire answer information DB 202C will be described later.

The control unit 201 is an operation apparatus that manages control exercised by the management server 20. The control unit 201 is an operation processing apparatus such as a CPU. The control unit 201 is provided with a terminal communication unit 2011, a reservation processing unit 2012 and a matching processing unit 2013 as functional components. These functional components are implemented, for example, by the CPU executing a program stored the storage unit 202. The control unit 201 is an example of the “control unit.”

The terminal communication unit 2011 is an interface with the user terminal 10. The terminal communication unit 2011 receives, for example, riding user information and questionnaire answer information from the user terminal 10A and driving user information from the user terminal 10B via the communication unit 203. Furthermore, the terminal communication unit 2011 transmits the questionnaire screen to the user terminal 10A and transmits the questionnaire answer evaluation result to the user terminal 10B, for example.

The reservation processing unit 2012 performs control relating to riding reservation. More specifically, the reservation processing unit 2012 receives a riding reservation request from the user terminal 10A via the terminal communication unit 2011. The reservation processing unit 2012 receives a place of departure, a destination, a desired date and time to start traveling and the like together with the riding reservation request from the user terminal 10A

Upon receiving the riding reservation request from the user terminal 10A, the reservation processing unit 2012 requests matching from the matching processing unit 2013. The reservation processing unit 2012 receives, for example, information on the matched driving user regarding the riding user of the user terminal 10A from the matching processing unit 2013. The reservation processing unit 2012 transmits the riding reservation request to the user terminal 10B of the matched driving user regarding the riding user of the user terminal 1011 via the terminal communication unit 2011. The riding reservation information is transmitted together with the riding reservation request. The riding reservation information includes, for example, a scheduled joining point and a scheduled joining time, a desired getting-off place and a desired arrival time of a person wanting a ride and information on the person wanting a ride or the like. The information on the person wanting a ride included in the riding reservation information includes a user ID and attributes or the like of the person wanting a ride.

Upon receiving an OK response to the riding reservation request from the user terminal 10B via the terminal communication unit 2011, the reservation processing unit 2012 determines the establishment of the riding reservation and notifies the user terminal 10A of the riding user of the establishment of the riding reservation. Together with the notification of the establishment of the riding reservation, for example, the scheduled joining point, the scheduled joining time and the information on the driving user are also transmitted. The information on the driver also includes a user ID and attributes of the driver, information on the vehicle or the like.

Upon receiving the notification of completion of riding in the vehicle of the driving user from, for example, the user terminal 10A of the riding user, the reservation processing unit 2012 transmits the questionnaire answer request and the questionnaire screen to the user terminal 10A via the terminal communication unit 2011. Upon receiving the questionnaire answer information from the user terminal 10A of the riding user via the terminal communication unit 2011, the reservation processing unit 2012 stores the received questionnaire answer information in the questionnaire answer information DE 203C.

Upon receiving the questionnaire answer information about, for example, one driving user, in a predetermined period or newly, the reservation processing unit 2012 totals the questionnaire answer information of the riding users in the vehicle, evaluates the totaling result and transmits the evaluation result to the user terminal 10B of the driving user. For example, the reservation processing unit 2012 calculates an average value scores of alternatives selected as a questionnaire answer for each item relating to the traveling environment, compares the average value of the scores with a threshold and thereby evaluates the questionnaire answer information.

For example, in the item of air conditioning, scores of −2, −1, 0, +1 and +2 are assigned to alternatives of “hot,” “a little hot,” “appropriate,” “a little cold” and “cold” respectively. For example, when the average value of scores of the questionnaire answer results of all the riding users in the vehicle is −2 or more and less than −1, the reservation processing unit 2012 determines that the “in-vehicle temperature is high.” For example, when the average value of the scores of the questionnaire answer result is −1 or more and less than +1, the reservation processing unit 2012 determines that the “in-vehicle temperature is an appropriate temperature.” For example, when the average value of the scores of the questionnaire answer result is +1 or more and less than +2, the reservation processing unit 2012 determines that the “in-vehicle temperature is low.”

Furthermore, the reservation processing unit 2012 generates an instruction for the driving user according to the average value of the scores of the questionnaire answer result. For example, when the average value of the scores of the questionnaire answer result is −2 or more and less than −1, the reservation processing unit 2012 generates an instruction for “reducing a set temperature of air conditioning by 2° C.” For example, when the average value of the scores of the questionnaire answer result is +1 or more and less than +2, the reservation processing unit 2012 generates an instruction for “increasing the set temperature of air conditioning by 2° C.” Note that, for example, when the average value of the scores of the questionnaire answer result is −1 or more and less than +1, the reservation processing unit 2012 evaluates that the “in-vehicle temperature is an appropriate temperature,” and so there is no need to change the temperature of air conditioning, no instruction for the driving user is generated. The instruction for the driving user generated according to the average value of the scores of the questionnaire answer result is an example of an “instruction for adjustment of the traveling environment in the vehicle.”

For other items relating to the traveling environment, evaluations and instructions are generated, for example, as follows. For example, the item of audio volume is as follows. In the item of audio volume, scores of −2, −1, 0, +1 and +2 are assigned to alternatives of “noisy,” “a little noisy,” “appropriate,” “small” and “a little small” respectively. For example, when the average value of the scores of the questionnaire answer result of all the riding users in the vehicle is −2 or more and less than −1, the reservation processing unit 2012 determines that “audio volume is large.” For example, when the average value of the scores of the questionnaire answer result is −1 or more and less than +1, the reservation processing unit 2012 determines that the “audio volume is appropriate ” For example, when the average value of the scores of the questionnaire answer result is +1 or more and less than +2, the reservation processing unit 2012 determines that the “audio volume is small.”

Furthermore, for example, when the average value of the scores of the questionnaire answer result is −2 or more and less than −1, the reservation processing unit 2012 generates an instruction for “reducing the audio volume by 2.” For example, when the average value of the scores of the questionnaire answer result is +1 or more and less than +2, the reservation processing unit 2012 generates an instruction for “increasing the audio volume by 2.”

For example, the item of fellow passengers is as follows. In the item of fellow passengers, scores of 2, −1, 0, +1 and +2 are assigned to alternatives of “annoying,” “a little annoying,” “no problem,” “a little friendly” and “friendly” respectively. For example, when the average value of the scores of the questionnaire answer result of all the riding users in the vehicle is −2 or more and less than −1, the reservation processing unit 2012 determines that the “riding user in the vehicle is passive.” For example, when the average value of the scores of the questionnaire answer result is −1 or more and less than +1, the reservation processing unit 2012 determines that the “riding user in the vehicle is satisfied.” For example, when the average value of the scores of the questionnaire answer result is +1 or more and less than +2, the reservation processing unit 2012 determines the “riding user in the vehicle is active.”

For example, when the average value of the scores of the questionnaire answer result is −2 or more and less than −1, the reservation processing unit 2012 generates an instruction for “not talking to the riding user.” For example, when the average value of the scores of the questionnaire answer result is +1 or more and less than +2, the reservation processing unit 2012 generates an instruction for “talking to the riding user.”

For example, the item of a speed is as follows. In the item of audio volume, scores of −2, −1, 0, +1 and +2 are assigned to alternatives of “fast,” “a little fast,” “appropriate,” “a little slow” and “slow” respectively. For example, when the average value of the scores of the questionnaire result of all the riding users in the vehicle is −2 or more and less than −1, the reservation processing unit 2012 determines that the “speed is fast.” For example, when the average value of the scores of the questionnaire answer result is −1 or more and less than +1, the reservation processing unit 2012 determines that the “speed is appropriate.” For example, when the average value of the scores of the questionnaire answer result is +1 or more and less than +2, the reservation processing unit 2012 determines that the “speed is slow.”

For example, when the average value of the scores of the questionnaire answer result is −2 or more and less than −1, the reservation processing unit 2012 generates an instruction for “reducing the speed.” For example, when the average value of the scores of the questionnaire answer result is +1 or more and less than +2, the reservation processing unit 2012 generates an instruction for “increasing the speed within a legal speed range.” Note that the item relating to the traveling environment, alternatives of the respective items, scores assigned to the respective alternatives, an evaluation method based on the average value of scores, instructions according to evaluation results are examples and can be set flexibly according to the embodiment respectively, and not limited to the above description.

The reservation processing unit 2012 transmits evaluations of questionnaire answer results, instructions based thereon to, for example, the user terminal 10B of the driving user. Note that when the vehicle of the driving user is mounted with a vehicle-mounted apparatus that can communicate with the management server 20 and control the vehicle equipment, the reservation processing unit 2012 may transmit the evaluations of questionnaire answer results and instructions based thereon to the vehicle-mounted apparatus.

In response to a request from the reservation processing unit 2012, the matching processing unit 2013 performs matching between the riding user corresponding to the user terminal 10A which is the source of the riding reservation request and the driving user. The matching method of the matching processing unit 2013 may be any one of well-known techniques and is not limited to a specific method. For example, the matching processing unit 2013 extracts from the driving user information DE 203B, driving users having a traveling schedule including the date and time at which traveling of the vehicle starts before the desired traveling starting date and time according to the riding reservation request and places of departure and destinations of riding users as the destination or passing spot and in the vicinity thereof. The matching processing unit 2013 selects a matching partner of a person wanting a ride randomly or based on evaluation values, attributes or the like from among the extracted driving users.

The matching processing unit 2013 determines a scheduled joining point based on, for example, the place of departure and destination of the riding user and the traveling route of the driving user. The matching processing unit 2013 determines the scheduled joining time based on the date and time at which the riding user wants to start traveling and the date and time at which the driving user starts driving the vehicle. The method for determining the scheduled joining point and the scheduled joining time may be any one of well-known techniques and is not limited to a specific method. The matching processing unit 2013 outputs information on the selected driving user, the scheduled joining point, the scheduled joining time or the like to the reservation processing unit 2012.

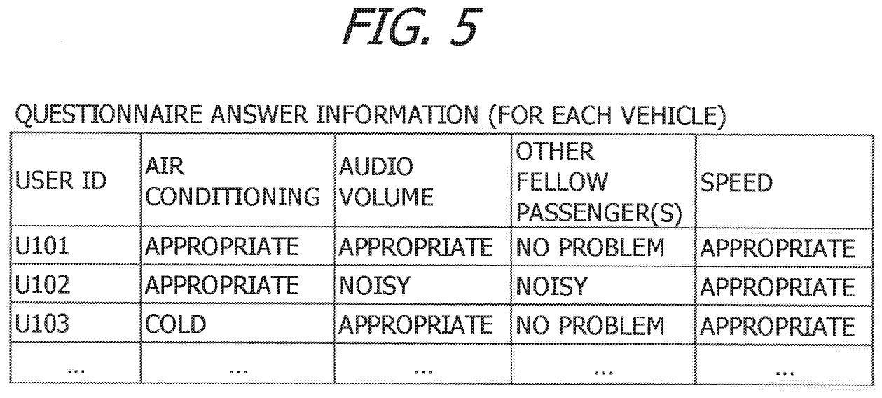

FIG. 5 is an example of a questionnaire answer information table. The questionnaire answer information table is stored in the questionnaire answer information DE 202C. The questionnaire answer information table is a table that stores questionnaire answer information of a riding user in the vehicle. One questionnaire answer information table is provided, for example, for each vehicle or each driving user.

One entry of the questionnaire answer information table is questionnaire answer information of one riding user in the corresponding vehicle. Questionnaire answer information of users having user IDs of U101, U102 and U103 is registered, for example, in the questionnaire answer information table illustrated in FIG. 5. Entries of the questionnaire answer information table are generated by the reservation processing unit 2012 when, for example, questionnaire answer information is received from the user terminal 10A of the riding user. Furthermore, when, for example, questionnaire answer information is collected in a predetermined period, the corresponding entry in the questionnaire answer information table is updated every time the questionnaire answer information is received from the user terminal 10A of the riding user.

For example, upon receiving a notification that the riding user has got out from the vehicle, that is, that the service of riding reservation by the riding user has been completed from the user terminal 10B of the driving user of the vehicle or/and from the user terminal 10A of the riding user, entries of the questionnaire answer information table corresponding to the user ID of the riding user are deleted.

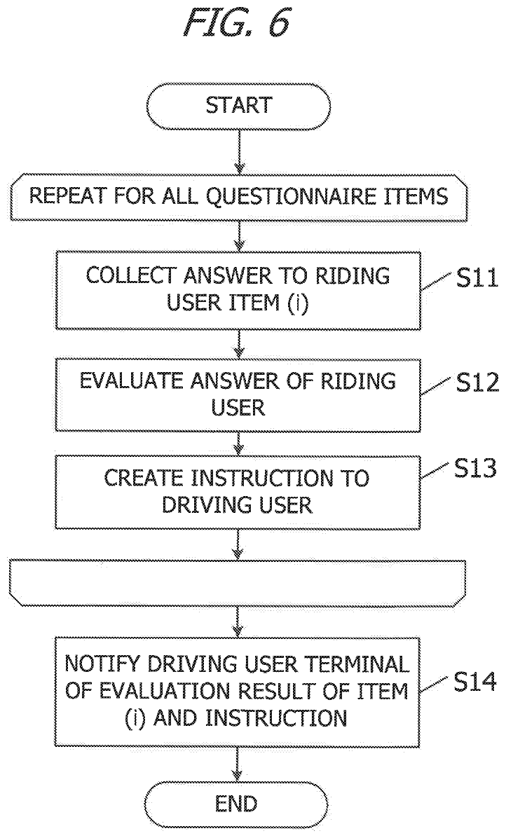

FIG. 6 is an example of a flowchart of questionnaire answer evaluation processing of the reservation processing unit 2012 of the management server 20. The questionnaire answer evaluation processing is processing of evaluating questionnaire answer information of a riding user in the vehicle. The processing illustrated in FIG. 6 is started in a predetermined periods or upon the occurrence of a predetermined event, for example, for one vehicle of the driving user. The predetermined event which prompts the processing illustrated in FIG. 6 to start is, for example, reception of questionnaire answer information from the user terminal 10A of the riding user in the vehicle. The execution subject of the processing illustrated in FIG. 6 is actually the control unit 201, but the functional components are described as the subjects for convenience' sake.

Processes in S11 to S13 are repeatedly executed by the number of questionnaire items. In S11, the reservation processing unit 2012 acquires an answer to an item (i) (i: positive integer) of a riding user in a target vehicle from a questionnaire answer information table of the target vehicle. When there are a plurality of riding users in the target vehicle, answers of the plurality of riding users are acquired.

In S12, the reservation processing unit 2012 evaluates the answer to the item (i) of the riding user. The method for evaluating the answer to the questionnaire is, for example, as described above, and the reservation processing unit 2012 calculates an average value of scores of alternatives of the answer, compares the average value with a threshold and acquires an evaluation result. However, the method for evaluating the answer to the questionnaire is not limited to this.

In S13, the reservation processing unit 2012 generates an instruction for the driving user of the target vehicle based on the evaluation result of the answer to the questionnaire. The instruction for the driving user is generated, for example, as described above.

In S14, the reservation processing unit 2012 transmits the evaluation result of the answer to the questionnaire for each item of the questionnaire on the target vehicle and the instruction generated to the user terminal 10B of the driving user of the target vehicle. After that, the processing illustrated in FIG. 6 ends.

<Operations and Effects of First Embodiment>

In the first embodiment, the user who gets in the vehicle in a ride sharing service answers a questionnaire on a traveling environment and the traveling environment is adjusted based on the answer result of the questionnaire. Thus, the riding user can indirectly communicate his/her intention regarding the traveling environment, facilitating communication between the riding users in the same vehicle and driving user. Furthermore, since the evaluation result of the answer to the questionnaire does not include information on the riding user who answers the questionnaire, anonymity is secured and the riding user can easily feel free to express his/her intention regarding the traveling environment.

In the first embodiment, the questionnaire answer of the riding user in the vehicle is evaluated by the management server 20 and the evaluation result is fed back to the driving user of the vehicle, and so the driving user can adjust the traveling environment so as to match the intention of the riding user

### Other Embodiments

The embodiment described above is an example, and the present disclosure may be changed and carried out as appropriate without departing from the gist of the present disclosure.

In the first embodiment, the vehicle used for a ride sharing service has been described as a vehicle manually driven by a driving user, but the embodiment is not limited to this. An autonomously driving vehicle may also be used for the ride sharing service. When an autonomously driving vehicle is used, the evaluation result of the questionnaire answer information of a riding user and an instruction generated based on the evaluation result are transmitted to a computer mounted on the autonomously driving vehicle.

In the first embodiment, an instruction generated based on an evaluation result of questionnaire answer information together with the evaluation result is also transmitted to the user terminal 10B of the driving user, but the present disclosure is not limited to this. For example, the evaluation result of the questionnaire answer information may be transmitted to the user terminal 10B of the driving user, but the instruction generated based on the evaluation result may be neither generated not transmitted to the user terminal 10B of the driving uses. This is because notifying the evaluation result of the questionnaire answer information allows the driving user to be motivated to improve the traveling environment.

In the first embodiment, information on the intention relating to the traveling environment of the riding user in the vehicle is collected not exclusively in a questionnaire format. For example, information on the intention relating to the traveling environment of the riding user in the vehicle may also be collected in a free filling format.

In the first embodiment, alternatives for each item of the questionnaire relating to the traveling environment are not limited to characters but may be icons, pictographs or the like. Evaluation results of answers to a questionnaire fed back to the driving user are not limited to characters, but may also be icons, pictographs or the like.

In the first embodiment, evaluation results of answers to a questionnaire of a riding user relating to the traveling environment are fed back to the driving user in the vehicle alone, but the present disclosure is not limited to this, and the evaluation results may be fed back, for example, to the driving user and all the riding users in the vehicle. A case has been described in the first embodiment where the riding user solely answers the questionnaire, but the driving user as well as the riding users may likewise be caused to answer the questionnaire.

Although a case has been described in the first embodiment where the present disclosure is applied to ride sharing in which matching is performed between a driving user who drives a vehicle and a riding user who wants to travel in the vehicle and both users travel by sharing the same vehicle, the technique described in the first embodiment is not solely applicable to ride sharing. For example, the present technique is also applicable to a traveling service using a vehicle such as a taxi or a bus (particularly an express bus or the like) which may carry a plurality of passengers. For example, in a night express bus, when bright light of a smartphone operated by a fellow passenger inhibits the sleep of a certain riding user, the riding user may send questionnaire answer information indicating the problem to the management server 20 so that the management server 20 may instruct the driving user to broadcast a request to refrain from operating the smartphone.

The processes and means described in the present disclosure may be freely combined to the extent that no technical conflict exists.

A process which is described to be performed by one device may be performed divided among a plurality of devices. Processes described to be performed by different devices may be performed by one device. Each function is to be implemented by which hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing apparatus comprising a processor configured to
acquire first information relating to an intention of at least one of a plurality of users traveling in a same vehicle regarding a traveling environment in the vehicle; and
transmit the first information to at least an apparatus associated with the vehicle.

2. The information processing apparatus according to claim 1, wherein the processor is configured to:
evaluate the first information and generating an evaluation result; and
transmit the evaluation result to the apparatus associated with the vehicle.

3. The information processing apparatus according to claim 2, wherein the processor is configured to:
generate an instruction for adjusting the traveling environment by the vehicle based on the evaluation result; and
transmit the generated instruction to the apparatus associated with the vehicle.

4. The information processing apparatus according to claim 2, wherein
the processor is configured to acquire the first information of some or all of the plurality of users in the vehicle, and
evaluate the first information of some or all of the users and generates evaluation results.

5. The information processing apparatus according to claim 1, wherein the apparatus associated with the vehicle is a terminal associated with the driver of the vehicle.

6. An information processing system comprising at least one processor configured to:
acquire first information relating to an intention of at least one of a plurality of users traveling in a same vehicle regarding a traveling environment in the vehicle; and
transmit the first information to at least an apparatus associated with the vehicle.

7. An information processing method comprising:
acquiring first information relating to an intention of at least one of a plurality of users traveling in a same vehicle regarding a traveling environment in the vehicle; and
transmitting the first information to at least an apparatus associated with the vehicle.
